(19) United States
(12) Patent Application Publication
(10) Pub. No.: US 2007/0108426 A1
(43) Pub. Date: May 17, 2007

(54) Process for enhancing or creating fire retardant and resistance properties to flammable materials and coating having such properties

(75) Inventor: Yosef Labock, Hallandale, FL (US)

Correspondence Address: LERNER GREENBERG STEMER LLP, P O BOX 2480, HOLLYWOOD, FL, 33022-2480, US

(73) Assignee: Labock Technologies, Inc.

(21) Appl. No.: 11/281,351

(22) Filed: Nov. 17, 2005

(51) Int. Cl. C09K 21/00

(52) U.S. Cl. 252/606

(57) ABSTRACT

A process for enhancing or creating fire retardant, fire resistance, and heat resistance properties to flammable materials includes the steps of applying a covering layer of a, preferably, non flammable paint, carrying out a convection/radiation drying phase, and applying a cover of a heat insulating material, such as silicone-based sealants. A convection/radiation drying phase, is then carried out. Finally, a cover of a water-based non-flammable paint is applied.

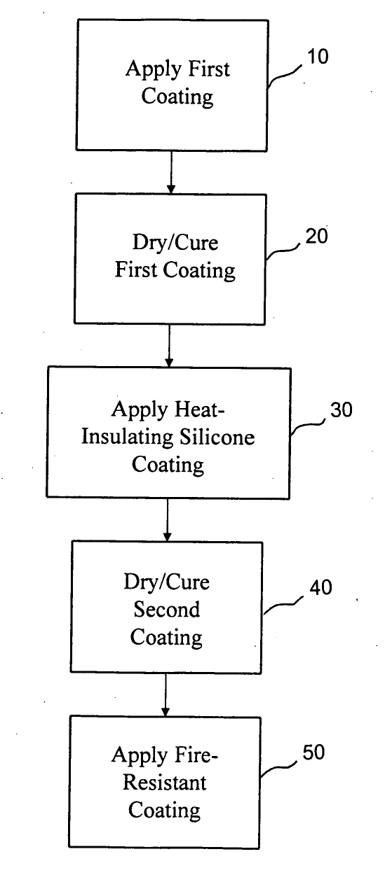

### BACKGROUND OF THE INVENTION

The invention relates generally to the field of fire and heat treatments of materials and more specifically to a process for enhancing or creating fire retardant and resistance properties to flammable materials and a coating having such properties.

The traditional way to deal with elements, parts, or materials that will be submitted to fire and heat exposure is to construct those elements using materials that will, by themselves, be capable of sustaining that exposure. The appearance of new plastic materials and chemicals generated new solutions that allowed the creation of a raw material with enhanced fire and heat exposure properties in relation to similar products. As an example, in some cases, such as in cables, the composition of the plastic covering is made such that it will retard combustion and, when combustion occurs, will not produce toxic or corrosive gas, or, in other cases, such as wood for construction, chemical processes exist that incorporate agents that will retard the combustion in the material itself.

Another existing solution is paint that partially protects from heat and fire and can be applied after the product has been fabricated. However these products have limitations and, in some cases, when they reach the limit of their resistance, generate vapors or gases that can be toxic.

There is a need for a process that would allow certain finished products to be treated after they have been produced so that they can acquire advanced capabilities of withstanding fire and extreme heat without generating toxic byproducts when exposed thereto.

### SUMMARY OF THE INVENTION

It is accordingly an object of the invention to provide a process for enhancing or creating fire retardant and resistance properties to flammable materials and coating having such properties that overcome the hereinafore-mentioned disadvantages of the heretofore-known devices and methods and devices of this general type and that create fire resistant properties in materials, including flammable materials, that create fire retardant properties in materials, including flammable materials, that enhance fire resistance, fire retardant, and heat resistance capabilities in materials, and that increase resistance to natural environmental agents.

With the foregoing and other objects in view, there is provided, in accordance with the invention, a process for enhancing or creating fire retardant, fire resistance, and heat resistance properties to flammable materials which include the steps of completely covering an object to be protected with non flammable paint, carrying out a drying phase by convection and/or radiation, completely covering the object with a heat insulating material, such as silicone-based sealants, carrying out a drying phase by convection and/or radiation, and applying a final cover of a water-based non-flammable paint. This process enhances the heat resistance of any material, including non resistant materials such as STYROFOAM.

The existing solution calls for special materials or specially treated materials that have, by a process according to the invention, enhanced properties in regards to fire and heat exposure. From those raw materials, the final product is derived inheriting the properties of the raw material used.

In accordance with another mode of the invention, there is provided a method of enhancing or creating fire and heat retardant and resistance properties to flammable materials, including the steps of applying a first cover of a non-flammable paint, drying the first cover in a first drying phase, applying a second cover of a heat insulating material, drying the second cover in a second drying phase, and applying a third cover of a water-based non-flammable paint.

With the objects of the invention in view, there is also provided a method of enhancing or creating fire and heat retardant and resistance properties to a flammable object, including the steps of completely covering the object with a non-flammable paint, carrying out a first drying phase of the object covered with the non-flammable paint, completely covering the first dried object with a heat insulating material, carrying out a second drying phase of the object covered with the heat insulating material, and completely covering the second dried object with a water-based non-flammable paint.

In accordance with a further mode of the invention, the first drying phase is carried out with a convection drying source and/or a radiation drying source.

In accordance with an added mode of the invention, the first drying phase is carried out to partially or incompletely dry the first cover. In particular, the first cover is a non-flammable paint.

In accordance with an additional mode of the invention, the second covering step is carried out with a silicone-based sealant.

In accordance with yet another mode of the invention, the second drying phase is carried out with a convection drying source and/or a radiation drying source.

In accordance with yet a further mode of the invention, the second drying phase is carried out to partially or incompletely dry the second cover. In particular, the second cover is a silicone-based sealant.

In accordance with yet an added mode of the invention, the first cover is applied to a foam object or a polystyrene object.

With the objects of the invention in view, there is also provided a coating enhancing or creating fire and heat retardant and resistance properties to flammable materials, including a liquid non-flammable paint being allowed to partially dry, a liquid heat insulating material applied to the partially dried non-flammable paint, and a liquid, water-based, non-flammable paint applied to the partially dried heat-insulating material.

With the objects of the invention in view, there is also provided a coating enhancing or creating fire and heat retardant and resistance properties to flammable materials, including a liquid non-flammable paint, a liquid heat insulating material applied to the non-flammable paint before the non-flammable paint is completely dry, and a liquid, water-based, non-flammable paint applied to the heat-insulating material before the heat-insulating material is completely dry.

With the objects of the invention in view, in combination with a foam object or a polystyrene object, a coating enhancing or creating fire and heat retardant and resistance properties to the object is provided. A coating formed of a liquid non-flammable paint is applied to the object and allowed to partially dry. A liquid heat insulating material is applied to the partially dried non-flammable paint, and a liquid, water-based, non-flammable paint is applied to the partially dried heat-insulating material.

With the objects of the invention in view, in combination with one of a foam object and a polystyrene object, a coating enhancing or creating fire and heat retardant and resistance properties to the object is provided. A coating formed of a liquid non-flammable paint is applied to the object. A liquid heat insulating material is applied to the non-flammable paint before the non-flammable paint is completely dry, and a liquid, water-based, non-flammable paint applied to the heat-insulating material before the heat-insulating material is completely dry.

In accordance with a concomitant feature of the invention, the heat-insulating material is a silicone-based sealant.

Other features that are considered as characteristic for the invention are set forth in the appended claims.

Although the invention is illustrated and described herein as embodied in a process for enhancing or creating fire retardant and resistance properties to flammable materials and a coating having such properties, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

The single FIGURE of the drawing is a flow chart for describing a method of applying a fire retardant coating according to the invention.

### DETAILED DESCRIPTION OF THE PREFERRED EMBODIMENTS

Detailed descriptions of the preferred embodiment are provided herein. It is to be understood, however, that the invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The process according to the invention applies to any material, especially those that are flammable, combustible, or are affected in their properties by heat. The process has been tested on STYROFOAM and ultra high-density polyethylene materials with success. Specifically, there is at least a ten-fold increase in the amount of time that the products treated according to the invention can withstand a burning substance applied to it, such as gasoline or a solvent.

Referring now to the single FIGURE of the drawing, it is seen that the process starts with a clean object that is treated by having a first coating disposed on the object, step 10. The object is completely covered with the first coating. “Completely covered” means that no portion of the original object is visible after the coating process and that the coating material has at least a minimal thickness such that the objected is completely sealed by the first coating.

Preferably, the first coating is a water-based paint and, in particular, a non-flammable, water-based paint. Example paints include commercially available water-based paints such as those used for internal or external protection of buildings. The purpose of the first coating is to seal the material to be treated so that the following coating process is locked in place and does not migrate inside the intended protected material. Such a migration could deteriorate and age the object and reduce the intended protection properties and, also, possibly affect the intended material to be protected. Selection of the first coating has to be made such that it respects the integrity of the intended material to be protected while also cooperating with the final intended result. It has, surprisingly, been found that water-based paints are coatings that provide a better substrate for the remaining process steps. Examples of the water-based paints include commercially available, water-based paints such as those used for internal or external protection of buildings.

In a second step 20, the first coating is dried enough so as to hold itself on the intended protected material but so that it is not totally cured or completely dry to favor adherence with a subsequent coating. Decay in the quality of adherence to the first coating layer has been detected when the samples are completely cured or dry. A combined process of radiation and convection of hot air usually produces the best result in a very short time. This combined process is usually accomplished by exposing the treated sample to a current of hot and dry air while at the same time receiving infrared radiation from a quartz lamp.

In a third step 30, the partially dried object is completely covered with a heat-insulating layer, in particular, a silicone-based product. This step creates the desired heat-insulating layer. Example silicone-based products include commercially available silicone-based sealants such as those intended to seal window frames and those sealants with a higher silicone proportion produce better results. The purpose of the heat-insulating layer is to create a thin coating (e.g. 0.075 inches thick) with heat resistant properties that minimize the heat transferred to the protected material. Generally, objects dipped in the selected silicone-based product produce favorable and adequate results.

A new exposure to radiation and hot air convection is needed to cure the second coating to a solid state. Once again, this is accomplished by exposing the treated sample to a current of hot and dry air while, at the same time, receiving infrared radiation from a quartz lamp, step 40. The process shows improvement when it is carried out simultaneously and the time involved is approximately 75% of the recommended curing time to handle the treated part in accordance to the silicone sealant manufacturer. The radiation and hot air convection is the preferred method because of the short time involved.

The object so treated is, then, covered with a final coating of any commercial paint that has fire-resistant capabilities, step 50. Several different companies offer such commercially available paints for different purposes, such as covering wood or metals. The final coating layer is the layer that will be either in contact with the heat or flames or will withstand a burning substance applied to it, such as gasoline or solvent. Additionally, a final exterior coating can be applied on the finished product, e.g. for ultraviolet (UV) protection or any other coating that meets the requirement for final exposure to the elements.

One surprising result discovered is that foam, including closed-cell foams of extruded polystyrene, STYROFOAM, and similar synthetic products treated this way can survive significantly longer than in previous similar conditions. Specifically, an untreated treated sample of STYROFOAM is completely burned within the first 15 seconds of exposure to burning of gasoline or solvent. In comparison, STYROFOAM treated according to the process of the present invention lasts more than two minutes under the same gasoline or solvent burning conditions before showing signs of deterioration.

Results of the process are particularly interesting when applied to regular plastics such as ultra high-density polyethylene—which show no effects after severe exposures to flames. For example, tested samples of this material underwent more than three minutes of burning in solvents and gasoline and kept both its shape and properties after the flames were extinguished.

While the invention has been described in connection with a preferred embodiment, it is not intended to limit the scope of the invention to the particular form set forth, but, on the contrary, it is intended to cover such alternatives, modifications, and equivalents as may be included within the spirit and scope of the invention as defined by the appended claims.

I claim:

1. A method of enhancing or creating fire and heat retardant and resistance properties to flammable materials, which comprises:
applying a first cover of a non-flammable paint;
drying the first cover in a first drying phase;
applying a second cover of a heat insulating material;
drying the second cover in a second drying phase; and
applying a third cover of a water-based non-flammable paint.

2. The method according to claim 1, which further comprises carrying out the first drying phase with at least one of a convection drying source and a radiation drying source.

3. The method according to claim 2, which further comprises carrying out the first drying phase to partially dry the first cover such that the first cover is not fully dried or cured.

4. The method according to claim 2, which further comprises carrying out the first drying phase to incompletely dry the first cover.

5. The method according to claim 1, which further comprises carrying out the second covering step with a silicone-based sealant.

6. The method according to claim 1, which further comprises carrying out the second drying phase with at least one of a convection drying source and a radiation drying source.

7. The method according to claim 6, which further comprises carrying out the second drying phase to partially dry the second cover.

8. The method according to claim 6, which further comprises carrying out the second drying phase to incompletely dry the second cover.

9. The method according to claim 1, which further comprises:
applying the first cover to a foam object; and
stopping the second drying step after 75% of the recommended drying time has been completed.

10. The method according to claim 1, which further comprises applying the first cover to a polystyrene object.

11. A method of enhancing or creating fire and heat retardant and resistance properties to a flammable object, which comprises:
completely covering the object with a non-flammable paint;
carrying out a first drying phase of the object covered with the non-flammable paint;
completely covering the first dried object with a heat insulating material;
carrying out a second drying phase of the object covered with the heat insulating material; and
completely covering the second dried object with a water-based non-flammable paint.

12. The method according to claim 11, which further comprises carrying out the first drying phase with at least one of a convection drying source and a radiation drying source.

13. The method according to claim 12, which further comprises carrying out the first drying phase to partially dry the non-flammable paint.

14. The method according to claim 12, which further comprises carrying out the first drying phase to incompletely dry the non-flammable paint.

15. The method according to claim 11, which further comprises carrying out the second covering step with a silicone-based sealant.

16. The method according to claim 11, which further comprises carrying out the second drying phase with at least one of a convection drying source and a radiation drying source.

17. The method according to claim 16, which further comprises carrying out the second drying phase to partially dry the silicone-based sealant.

18. The method according to claim 16, which further comprises carrying out the second drying phase to incompletely dry the silicone-based sealant.

19. The method according to claim 11, which further comprises applying the non-flammable paint to a foam object.

20. The method according to claim 11, which further comprises applying the non-flammable paint to a polystyrene object.

21. The method according to claim 11, wherein the object is a foam object.

22. The method according to claim 11, wherein the object is a polystyrene object.

23. A coating enhancing or creating fire and heat retardant and resistance properties to flammable materials, comprising:
a liquid non-flammable paint being allowed to partially dry;
a liquid heat insulating material applied to said partially dried non-flammable paint; and
a liquid, water-based, non-flammable paint applied to said partially dried heat-insulating material.

24. The coating according to claim 23, wherein said heat-insulating material is a silicone-based sealant.

25. A coating enhancing or creating fire and heat retardant and resistance properties to flammable materials, comprising:
a liquid non-flammable paint;
a liquid heat insulating material applied to said non-flammable paint before said non-flammable paint is completely dry; and
a liquid, water-based, non-flammable paint applied to said heat-insulating material before said heat-insulating material is completely dry.

26. The coating according to claim 25, wherein said heat-insulating material is a silicone-based sealant.

27. In combination with one of a foam object and a polystyrene object, a coating enhancing or creating fire and heat retardant and resistance properties to the object, the coating comprising:
a liquid non-flammable paint applied to the object and being allowed to partially dry;
a liquid heat insulating material applied to said partially dried non-flammable paint; and
a liquid, water-based, non-flammable paint applied to said partially dried heat-insulating material.

28. The coating according to claim 27, wherein said heat-insulating material is a silicone-based sealant.

29. In combination with one of a foam object and a polystyrene object, a coating enhancing or creating fire and heat retardant and resistance properties to the object, the coating comprising:
a liquid non-flammable paint applied to the object;
a liquid heat insulating material applied to said non-flammable paint before said non-flammable paint is completely dry; and
a liquid, water-based, non-flammable paint applied to said heat-insulating material before said heat-insulating material is completely dry.

30. The coating according to claim 29, wherein said heat-insulating material is a silicone-based sealant.
